(19) United States
(12) Patent Application Publication
(10) Pub. No.: US 2025/0116007 A1
(43) Pub. Date: Apr. 10, 2025

(54) ELECTROCHEMICAL HYDROGEN SEPARATION AND GENERATION PROCESS FOR AMMONIA SYNTHESIS GAS

(71) Applicant: FuelCell Energy, Inc., Danbury, CT (US)

(72) Inventor: Jonathan MALWITZ, Danbury, CT (US)

(21) Appl. No.: 18/891,545

(22) Filed: Sep. 20, 2024

Related U.S. Application Data
(60) Provisional application No. 63/587,860, filed on Oct. 4, 2023.

(51) Int. Cl. C25B 1/27; C25B 15/029; H01M 8/0656

(52) U.S. Cl. CPC C25B 1/27; C25B 15/029; H01M 8/0656

(57) ABSTRACT

An ammonia generation system includes an electrochemical cell including a cathode configured to receive a cathode inlet stream comprising nitrogen gas, an anode configured to receive an anode inlet stream and form hydrogen ions, and an electrolyte configured to transport the hydrogen ions from the anode to the cathode. The cathode is configured to reduce the hydrogen ions to hydrogen gas, mix the hydrogen gas and the cathode inlet stream, and output a cathode outlet stream comprising a mixture of the hydrogen gas and the nitrogen gas. The ammonia generation system further includes an ammonia synthesis reactor configured to receive a reactor inlet stream comprising at least a first portion of the cathode outlet stream.

### CROSS-REFERENCE TO RELATED APPLICATIONS

This application claims the benefit of and priority to U.S. Provisional Patent Application No. 63/587,860, filed Oct. 4, 2023, which is incorporated by reference herein in its entirety.

### BACKGROUND

Ammonia is an inorganic compound of nitrogen and hydrogen with the formula NH₃. Ammonia is commonly used in fertilizers, cleaners, and solvents. The production of ammonia typically involves several steps to create a synthesis gas of hydrogen and nitrogen, which can then be fed into a reactor in the presence of a catalyst to form ammonia.

A fuel cell is a device that converts chemical energy stored in hydrocarbon fuel into electrical energy by means of an electrochemical reaction. Generally, a fuel cell comprises an anode and a cathode that are separated by an electrolyte, which conducts electrically charged ions to produce electricity. For example, in a solid oxide fuel cell (“SOFC”), a solid, gas-impervious electrolyte is sandwiched between a porous anode and a porous cathode. Oxygen is transported through the cathode to the cathode/electrolyte interface, where it is reduced to oxygen ions, which migrate through the electrolyte to the anode. At the anode, the ionic oxygen reacts with fuels such as hydrogen or methane to release electrons, which then travel back to the cathode through an external circuit to generate electric power. Molten carbonate fuel cells (“MCFCs”), in contrast, typically operate at temperatures between 600 and 700 degrees Celsius, and use an electrolyte composed of a molten carbonate salt mixture suspended in a porous, chemically inert ceramic matrix. At the cathode, carbon dioxide and oxygen react to form carbonate ions, which migrate through the electrolyte to react with a source of hydrogen (e.g., a hydrocarbon fuel) to produce steam, carbon dioxide, and electrons that then pass through an external circuit before flowing to the cathode.

In either case, anode exhaust is produced that may include a mixture of various components such as hydrogen, carbon monoxide, and/or carbon dioxide. Thus, the anode exhaust contains useful byproduct gases which can then be used for other purposes.

It would be advantageous to provide a system that utilizes such byproducts for the synthesis of other useful products.

### SUMMARY

One aspect of the present disclosure relates to an ammonia generation system. The ammonia generation system includes an electrochemical cell including a cathode configured to receive a cathode inlet stream including nitrogen gas, an anode configured to receive an anode inlet stream and form hydrogen ions, an electrolyte configured to transport the hydrogen ions from the anode to the cathode. The cathode is configured to reduce the hydrogen ions to hydrogen gas, mix the hydrogen gas and the cathode inlet stream, and output a cathode outlet stream including a mixture of the hydrogen gas and the nitrogen gas. The ammonia generation system further includes an ammonia synthesis reactor configured to receive a reactor inlet stream comprising at least a first portion of the cathode outlet stream.

In some embodiments, the ammonia generation system further includes a water transfer membrane assembly configured to receive the cathode outlet stream and a nitrogen stream, transfer steam from the cathode outlet stream to the nitrogen stream across a semi-permeable water transfer membrane, output the cathode inlet stream including the nitrogen stream and the transferred steam, and output the reactor inlet stream including the dried cathode outlet stream. In some embodiments, the electrochemical cell is an electrolyzer and the anode inlet stream comprises steam. In some embodiments, the electrochemical cell is an electrochemical hydrogen separator and the anode inlet stream comprises hydrogen gas. In some embodiments, the ammonia generation system further includes a fuel cell configured to output a fuel cell anode exhaust comprising hydrogen gas, wherein the anode inlet stream of the electrochemical cell comprises the fuel cell anode exhaust.

In some embodiments, the ammonia generation system further includes an ejector including a motive inlet configured to receive a nitrogen stream, and a suction inlet configured to receive a second portion of the cathode inlet stream, wherein the ejector is configured to output the cathode inlet stream including the second portion of the cathode inlet stream and the nitrogen stream.

In some embodiments, the ammonia generation system further includes a controller configured to control a flow rate of the cathode inlet stream and a flow rate of the anode inlet stream. In some embodiments, the ammonia generation system further includes at least one sensor communicatively coupled to the controller and configured to measure at least one of a hydrogen concentration in the cathode outlet stream or a nitrogen concentration in the cathode outlet stream. In some embodiments, the controller is configured to receive a hydrogen concentration measurement and a nitrogen concentration measurement from the at least one sensor, determine a molar ratio of hydrogen gas to nitrogen gas in the cathode outlet stream based on the hydrogen concentration measurement and the nitrogen concentration measurement, and adjust at least one of the flow rate of the cathode inlet stream or the flow rate of the anode inlet stream based on the determined molar ratio until the determined molar ratio is approximately 3:1.

In some embodiments, the anode inlet stream includes hydrogen gas and the electrochemical cell is an electrochemical hydrogen separator. In some embodiments, the electrochemical hydrogen separator comprises a phosphoric acid electrochemical cell, a polybenzimidazole membrane electrochemical cell, a polymer electrolyte membrane electrochemical cell, a solid acid electrochemical cell, or a protonic ceramic electrochemical cell.

In some embodiments, the anode inlet stream includes steam and the electrochemical cell is a protonic ceramic electrolysis cell or a polymer electrolyte membrane electrolysis cell.

Another aspect of the present disclosure relates to a method of generating ammonia. The method includes supplying an anode inlet stream to an anode of an electrochemical cell configured to produce hydrogen gas at a cathode of the electrochemical cell, supplying a cathode inlet stream including a nitrogen stream to the cathode of the electrochemical cell such that the cathode inlet stream mixes with the hydrogen gas to form a cathode outlet stream, and supplying a reactor inlet stream comprising at least a portion of the cathode outlet stream to an ammonia reactor.

In some embodiments, the method further includes removing steam from the cathode outlet stream to form a dried cathode outlet stream, and adding the removed steam to the nitrogen stream to form the cathode inlet stream, the reactor inlet stream comprising the dried cathode outlet stream.

In some embodiments, the method further includes separating the cathode outlet stream into a recycle stream and the reactor inlet stream, supplying the recycle stream to a suction inlet of an ejector, and supplying the nitrogen stream into a motive inlet of the ejector such that the ejector outputs the cathode inlet stream comprising the recycle stream and the nitrogen stream.

In some embodiments, the anode inlet stream comprises hydrogen gas and the electrochemical cell is an electrochemical hydrogen separator.

In some embodiments, the anode inlet stream comprises steam and the electrochemical cell is an electrolysis cell.

In some embodiments, the method further includes controlling a flow rate of the cathode inlet stream and a flow rate of anode inlet stream such that a molar ratio of hydrogen gas to nitrogen gas is proximately 3:1. In some embodiments, the method further includes detecting a nitrogen concentration in the cathode outlet stream, detecting a concentration of hydrogen in the cathode outlet stream, and adjusting at least one of the flow rate of the cathode inlet stream and the flow rate of anode inlet stream based on the detected concentrations.

In some embodiments, the method further includes operating a fuel cell to generate power and fuel cell anode exhaust, wherein the anode inlet stream of the electrochemical cell comprises the fuel cell anode exhaust.

The foregoing is a summary of the disclosure and thus by necessity contains simplifications, generalizations, and omissions of detail. Consequently, those skilled in the art will appreciate that the summary is illustrative only and is not intended to be in any way limiting. Other aspects, features, and advantages of the devices and/or processes described herein, as defined by the claims, will become apparent in the detailed description set forth herein and taken in conjunction with the accompanying drawings.

### BRIEF DESCRIPTION OF THE DRAWINGS

FIG. 1 is a schematic diagram of an ammonia generation system, according to some embodiments.

FIG. 2 is a schematic diagram of an ammonia generation system, according to some embodiments.

FIG. 3 is a schematic diagram of an ammonia generation system, according to some embodiments.

FIG. 4 is a flowchart illustrating a method of generating ammonia, according to some embodiments.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

As discussed above, ammonia (NH₃) may be produced by blending nitrogen gas and hydrogen gas in the presence of a metal catalyst under elevated pressure and temperature in an ammonia synthesis reactor. For example, nitrogen gas (N₂) and hydrogen gas (H₂) may be introduced into a pressure vessel at about 200-400 atmospheres of pressure and about 400-650 degrees Celsius in the presence of an iron-based catalyst. The primary reaction between the nitrogen gas and hydrogen gas may be:

N₂+3H₂→2NH₃

Thus, three mols of hydrogen gas are consumed for every mol of nitrogen gas. Accordingly, mixing hydrogen gas and nitrogen gas in a ratio of 3:1 may maximize the volumes of constituent gases that react to form ammonia. In typical ammonia production systems, hydrogen is produced using steam reforming of methane. First, sulfur compounds may be removed from a natural gas feedstock using catalytic hydrogenation. Hydrogen sulfide may be removed from the natural gas feedstock by passing the feedstock through a bed of zinc oxide, where it is converted to zinc sulfide. Next, the methane may be converted to carbon monoxide and hydrogen using catalytic steam reforming. A second reforming step in the presence of air may be performed, which may generate more hydrogen and carbon monoxide. Nitrogen from air is also introduced into the gas mixture at this step. The carbon monoxide and water may be converted to carbon dioxide and hydrogen in a water gas shift reaction. The carbon dioxide and water may then be separated from the hydrogen and nitrogen, and the hydrogen and nitrogen may be introduced into the pressure vessel to create ammonia.

In the embodiments of the present disclosure, hydrogen gas may be produced in a cathode of an electrochemical cell. For example, hydrogen be separated from a hydrogen-containing gas mixture using an electrochemical hydrogen separator (EHS) or separated from steam using an electrolyzer. When an EHS is used, the hydrogen-containing gas mixture may be provided to an anode of the EHS, and the hydrogen gas may be oxidized to hydrogen ions that may travel across an electrolyte to a cathode of the EHS. The hydrogen ions may be reduced to re-form hydrogen gas at the cathode. Nearly all of the remaining gases in the hydrogen-containing gas stream may pass through the anode without crossing over the electrolyte. When the electrochemical cell is an electrolyzer rather than an electrochemical hydrogen separator, steam may be supplied to the anode of the electrolyzer and oxidized in the anode to form hydrogen ions and oxygen gas. Nearly all of the oxygen gas and unreacted steam may be output from the anode, and the hydrogen ions may travel across an electrolyte to a cathode of the electrolyzer. The hydrogen ions may be reduced to hydrogen gas at the cathode.

While hydrogen gas is being formed in the cathode of the electrochemical cell, a nitrogen stream may be supplied to the cathode to sweep the hydrogen gas away from the electrochemical cell. The nitrogen gas may be supplied at a rate based on the rate of hydrogen gas produced at the cathode such that the ratio of the hydrogen to nitrogen is approximately 3:1. The mixed hydrogen and nitrogen stream may be supplied to a pressure vessel of an ammonia synthesis reactor for ammonia production as described above. The EHS or electrolyzer may replace several operations used to generate purified hydrogen (e.g., reforming, catalytic hydrogenation, hydrogen sulfide removal, etc.) and may separate hydrogen from gas streams containing additional constituent gases that may not be removed by the traditional processes described above. Additionally, supplying nitrogen to the cathode may aid in managing the temperature of the EHS and may lower the separation energy input (e.g., cell voltage). For example, nitrogen may be added to the electrochemical cell at a temperature lower than that of the anode input stream, thereby reducing the temperature of the electrochemical cell. Further, supplying nitrogen gas to the cathode may result in a gas blend with a 3:1 molar ratio of hydrogen to nitrogen, the ideal ratio for ammonia (i.e., NH₃) production. The flow rate of the hydrogen-containing gas or steam supplied to the anode and the flow rate of the nitrogen to the cathode may be controlled to maintain this ratio in the cathode outlet stream, which can then be supplied to an ammonia reactor. Passing nitrogen to the electrochemical hydrogen separator may lower the energy needed to separate the hydrogen from the input stream. Depending on the type of electrochemical cell, ammonia may be formed in situ in the electrochemical cell or a mixture of nitrogen and hydrogen may be formed, which can then be provided to an ammonia reactor downstream of the electrochemical cell. In some cases, a portion of the hydrogen and nitrogen may be converted to ammonia within the electrochemical cell, and the remainder may be converted in the ammonia reactor.

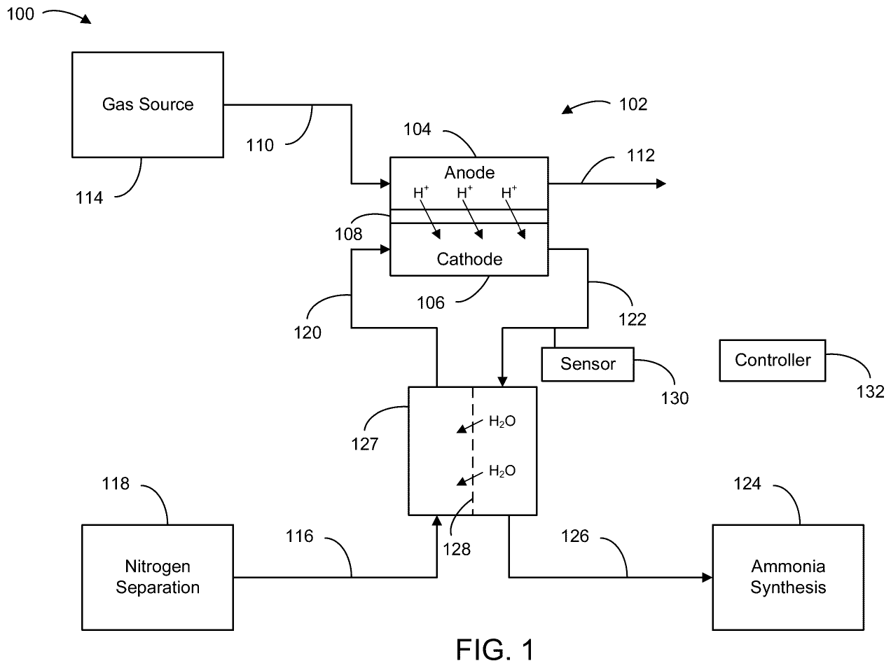

Referring to FIG. 1, a schematic diagram of a system 100 for producing ammonia synthesis gas is shown, according to some embodiments. The system 100 includes an electrochemical hydrogen separator (EHS) 102. The EHS 102 is an electrochemical cell including an anode 104 (e.g., an anode portion) and a cathode 106 (e.g., a cathode portion), which may be separated by a proton-conducting electrolyte 108, which is configured to transport hydrogen ions from the anode 104 to the cathode 106. The EHS 102 may be, for example, a phosphoric acid electrochemical cell (PAEC), a polybenzimidazole membrane electrochemical cell (PBI), a polymer electrolyte membrane electrochemical cell (PEM), a solid acid electrochemical cell (SAEC), or a protonic ceramic electrochemical cell (PCEC). It should be understood that while a single electrochemical cell is described herein, the EHS 102 may include multiple electrochemical cells in a stack or module, in which the respective anodes are arranged in series or in parallel, and the respective cathodes are arranged in series or in parallel.

An anode inlet stream 110 is supplied to the anode 104. The anode inlet stream 110 may contain hydrogen, in addition to varying amounts of carbon monoxide, carbon dioxide, methane, steam, nitrogen, helium, argon, and trace amounts of other gases. The anode inlet stream 110 may be received from a hydrogen-containing gas source 114, such as an anode outlet of a fuel cell (e.g., a natural gas solid oxide fuel cell, a molten carbonate fuel cell, etc.). The fuel cell may be configured to generate power from a gas mixture containing methane and/or hydrogen. Methane in the gas mixture may be converted to hydrogen in the presence of a reforming catalyst. In the anode of the fuel cell, a portion of the hydrogen may react with oxide ions or carbonate ions to form steam, while a portion of the hydrogen may not react and may be output from the fuel cell along with the steam in a fuel cell anode output stream. The fuel cell anode output stream from the fuel cell may be supplied to the anode 104 of the EHS 102 as at least a portion of the anode inlet stream 110. A current may be applied to the EHS 102, and the hydrogen gas may be oxidized into hydrogen ions at the anode 104. The hydrogen ions may be conducted across the electrolyte 108 to the cathode 106, where they may be reduced to re-form hydrogen gas. The remaining constituents of the anode inlet stream 110 may pass through the anode 104 without crossing the electrolyte 108 and are output from the anode 104 as an anode exhaust stream 112. This results in a highly pure stream of hydrogen being output from the cathode 106, while the anode exhaust stream 112 may contain all of the gases of the anode inlet stream 110 with a lower concentration of hydrogen. Unlike other methods of separating hydrogen gas from a mixed gas stream, such as pressure swing adsorption, in which the input gases must be completely dry, the EHS 102 may be tolerant of water (e.g., steam) in the anode inlet stream 110. In these other methods, the mixed gas stream must be cooled until the steam condenses and water can be removed before the hydrogen is separated. In contrast, the EHS 102 may receive hot, humid anode exhaust directly from a fuel cell and generate a substantially pure hydrogen stream without first condensing steam and removing water.

On the cathode side, a substantially pure nitrogen stream 116 may be output by a nitrogen separation assembly 118. The nitrogen separation assembly 118 may be or may include a pressure swing adsorber, a membrane separator, and/or a cold box (e.g., a cryogenic gas separation plant). The nitrogen stream 116 may be supplied to the cathode 106 in a cathode inlet stream 120 to act as a sweep gas to sweep the hydrogen formed in the cathode 106 away from the EHS 102. The mixture of the hydrogen gas and the cathode inlet stream 120 may be output from the cathode 106 as a cathode outlet stream 122 containing a mixture of hydrogen gas and nitrogen gas. At least a portion of the cathode outlet stream 122 may then be input into an ammonia synthesis reactor 124 as reactor inlet stream 126. The hydrogen and nitrogen in the reactor inlet stream 126 may then be converted to ammonia in the ammonia synthesis reactor 124. Supplying nitrogen in the cathode inlet stream 120 may help to control the temperature in the EHS 102 and may lower the separation voltage in the EHS 102, which may lower the energy cost of operating the EHS 102.

In some embodiments, a small amount of water (e.g., steam) and other gases in the anode inlet stream 110 may pass through cracks and voids in the electrolyte 108 from the anode 104 to the cathode 106. Thus, in addition to hydrogen and nitrogen, the cathode outlet stream 122 may include steam. Steam in the reactor inlet stream 126 may decrease the efficiency of the ammonia synthesis reactor 124. Therefore, it may be beneficial to remove steam from the cathode outlet stream 122. Rather than condensing the cathode outlet stream 122 to remove water and then reheating the remaining gases before supplying them to the reactor inlet stream 126, the system 100 may include a water transfer membrane assembly 127 including a semi-permeable water transfer membrane 128. The water transfer membrane assembly 127 may receive the cathode outlet stream 122 on one side of the water transfer membrane 128 and the nitrogen stream 116 on the other side. Steam in the cathode outlet stream 122 may be transferred across the membrane and mixed with the nitrogen stream 116. The mixture may then be output from the water transfer membrane assembly 127 as at least a portion of the cathode inlet stream 120. The steam in the cathode inlet stream 120 may also hydrate the cathode 106 and the electrolyte 108, which may improve proton conduction, depending on the type of EHS 102. In some embodiments, a portion of the steam may be removed from the system after being isolated in the water transfer membrane assembly 127 but before being mixed with the nitrogen stream 116. On the other side of the water transfer membrane 128, the now-dried cathode outlet stream 122 may be output from the water transfer membrane assembly 127 as at least a portion of the reactor inlet stream 126. The water transfer membrane 128 may not be included in some embodiments, for example, when the EHS 102 is a low-temperature PEM or a SAEC. In some embodiments, the pressure in the cathode 206 may be maintained at a higher pressure than the anode 204, such that water remains on the anode 204 side of the electrochemical hydrogen separator 202 (e.g., when the electrochemical cells are lower-temperature proton-conducting cells).

The system 100 may include a controller 132 that may be configured to control the flow rates of the anode inlet stream 110 and the cathode inlet stream 120. For example, the controller 132 may be communicatively coupled to the hydrogen-containing gas source 114 and the nitrogen separation assembly 118 and may control valves, blowers, and other components of the hydrogen-containing gas source 114 and/or the nitrogen separation assembly 118 to control the flow rates of gases therefrom. The controller 132 may control the flow rates such that the molar ratio of hydrogen to nitrogen in the cathode outlet stream 122 or the reactor inlet stream 126 is approximately 3:1. The system 100 may further include sensors 130 communicatively coupled to the controller 132 and configured to measure the concentration of gases (e.g., hydrogen and nitrogen) at various points in the system 100. For example, one or more sensors 130 may be used to measure the concentration of hydrogen and nitrogen in the cathode outlet stream 122. The controller 132 may receive measurements from the sensors 130 and may determine the molar ratio of hydrogen gas to nitrogen gas in the cathode outlet stream 122. If the molar ratio of hydrogen to nitrogen exceeds 3:1, the controller 132 may increase the flow rate from the nitrogen separation assembly and/or may decrease the flow rate from the hydrogen-containing gas source 114 until the 3:1 ratio is achieved. If the molar ratio of hydrogen to nitrogen is less than 3:1, the controller 132 may decrease the flow rate from the nitrogen separation assembly may be decreased and/or may increase the flow rate from the hydrogen-containing gas source 114 until the 3:1 ratio is achieved.

Sensors 130 may additionally or alternatively be positioned in other locations in the system 100. For example, sensors 130 may detect the concentration of hydrogen and nitrogen in a recycle stream of the ammonia synthesis reactor 124. The ammonia synthesis reactor 124 may not convert all of the hydrogen and nitrogen to ammonia before the gas is expelled from an outlet of the reactor 124. The remaining unreacted hydrogen and nitrogen may be recycled to the inlet of the reactor 124 for a second pass through the reactor 124 via the recycle stream. If the ratio of hydrogen to nitrogen in the reactor inlet stream is 3:1, the ratio of hydrogen to nitrogen in the recycle stream should also be 3:1, as hydrogen and nitrogen are consumed in the ammonia generation reaction in a 3:1 ratio. The controller may control the flow rates from the hydrogen-containing gas source 114 and the nitrogen separation assembly 118 such that the molar ratio of hydrogen to nitrogen in the reactor recycle stream is approximately 3:1. The controller may include at least one memory and at least one processor, the at least one memory may store instructions that, when executed by the at least one processor, cause the at least one processor to perform the functions described above (e.g., receiving sensor measurements, determining the ratio of hydrogen to nitrogen, sending control signals, etc.).

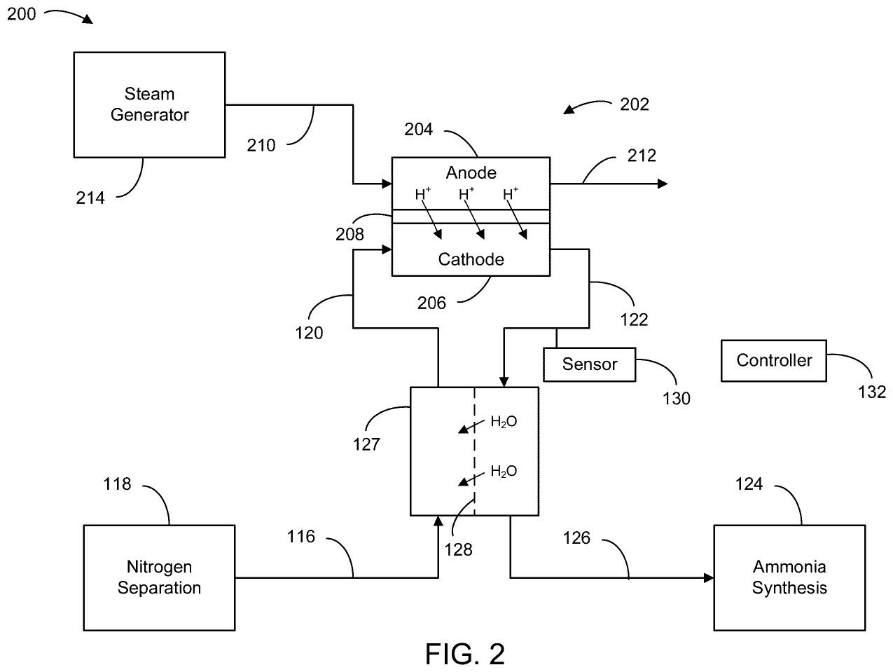

Referring now to FIG. 2, a schematic diagram of a system 200 for producing ammonia synthesis gas is shown, according to some embodiments. The system 200 may be substantially similar to the system 100, except as shown and described. The system 200 may include an electrolyzer 202 rather than an EHS 102. The electrolyzer 202 may be, for example, a protonic ceramic electrolysis cell, a PEM electrolysis cell, or another type of proton-conducting electrolysis cell (e.g., a stack or module of multiple electrolysis cells). Like the EHS 102, the electrolyzer 202 may include an anode 204 and a cathode 206 separated by an electrolyte 208. However, rather than separating hydrogen from a hydrogen-containing gas mixture, the electrolyzer 202 may be configured to electrolyze water (e.g., steam). Further, like the EHS 102, it should be understood that while a single electrolysis cell may be described herein, the electrolyzer 202 may refer to multiple electrolysis cells in a stack or module, in which the respective anodes are arranged in series or in parallel and the respective cathodes are arranged in series or in parallel.

An anode inlet stream 210 containing steam, and in some embodiments air, may be supplied to the anode 204 of the electrolyzer 202. The steam may be generated by a steam generator 214, which may be any device capable of generating steam, such as a boiler or a fuel cell. An electric current supplied to the electrolyzer 202 may cause water molecules to react at the anode 204 to form oxygen gas and hydrogen ions. Like in the EHS 102, the hydrogen ions cross the electrolyte 208 to the cathode 206, where they combine with electrons to form hydrogen gas at the cathode 206. The oxygen formed may not cross the electrolyte 208. Instead, nearly all of the oxygen, unreacted steam, and any air in the anode inlet stream 210 may flow out of the anode 204 as an anode outlet stream 212. The anode inlet stream 210 may include anode exhaust from a fuel cell (e.g., a molten carbonate fuel cell, a solid oxide fuel cell, etc.).

The cathode side of the system 200 may be substantially the same as the cathode side of the system 100. A substantially pure nitrogen stream 116 may be output by a nitrogen separation assembly 118. The nitrogen stream 116 may be supplied to the cathode 106 in a cathode inlet stream 120 to act as a sweep gas to sweep the hydrogen formed in the cathode 106 away from the electrolyzer 202. The mixture of the hydrogen gas and the cathode inlet stream 120 may be output from the cathode 106 as a cathode outlet stream 122 containing hydrogen and nitrogen. The cathode outlet stream 122 may then be input into an ammonia synthesis reactor 124 as reactor inlet stream 126. The hydrogen and nitrogen in the reactor inlet stream 126 may then be converted to ammonia in the ammonia synthesis reactor 124. Supplying nitrogen in the cathode inlet stream 120 may help to control the temperature in the electrolyzer 202 and may lower the separation voltage in the electrolyzer 202, which may lower the energy cost of operating the electrolyzer 202.

Like in the EHS 102, a small amount of water (e.g., steam) and other gases in the anode inlet stream 210 may pass through cracks and voids in the electrolyte 208 from the anode 204 to the cathode 206. Thus, in addition to hydrogen and nitrogen, the cathode outlet stream 122 may include steam. The system 200 may include a semi-permeable water transfer membrane 128. Steam in the cathode outlet stream 122 may be transferred across the membrane to the cathode inlet stream 120 to reduce the amount of steam in the reactor inlet stream 126. The steam in the cathode inlet stream 120 may also hydrate the cathode 206, which may be beneficial, depending on the type of electrolyzer 202. As discussed above, the system 100 and the system 200 may be substantially similar. However, by replacing the EHS 102 with the electrolyzer 202, the anode inlet stream 110 including hydrogen gas may be replaced with the anode inlet stream 210 including steam. In each system 100, 200 hydrogen gas is formed at the cathode 106, 206 and mixed with the cathode inlet stream 120 to form a cathode outlet stream containing primarily hydrogen and nitrogen. In each system 100, 200, the respective flow rates of the anode inlet stream 110, 210 and the cathode inlet stream 120 may be controlled such that the molar ratio of hydrogen to nitrogen is approximately 3:1.

The system 200 may include a controller 132 configured to control the flow rates of the anode inlet stream 210 and the cathode inlet stream 120, as discussed above with respect to the system 100. The system 200 may include sensors 130 communicatively coupled to the controller 132 and configured to measure the concentrations of hydrogen and/or nitrogen at various points in the system 200. The controller 132 may adjust the flow rates based on the data from the sensors 130.

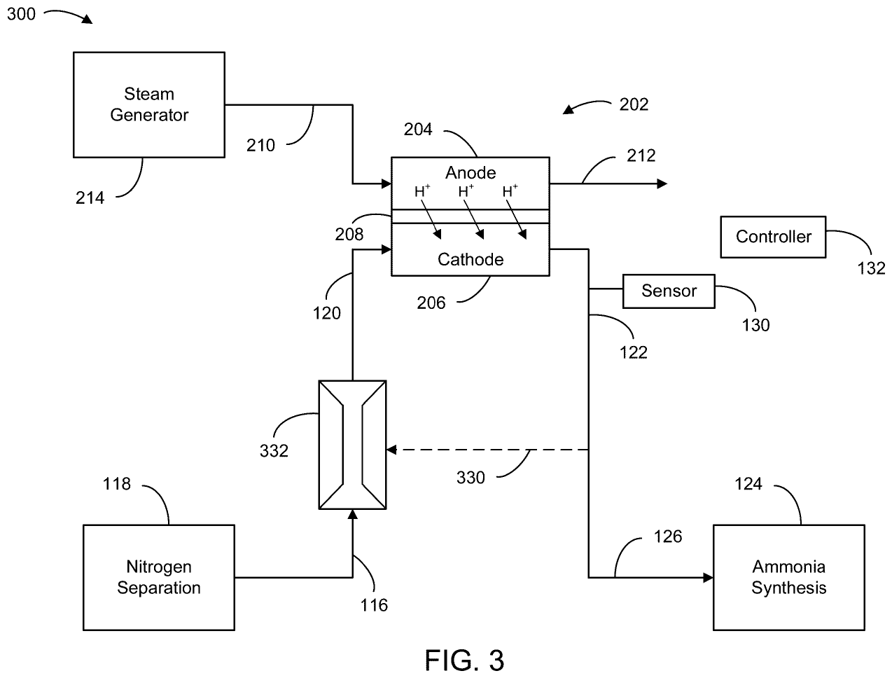

Referring now to FIG. 3, a schematic diagram of a system 300 for producing ammonia synthesis gas is shown, according to some embodiments. The system 300 may be substantially similar to the system 200, except as shown and described. Like the system 200, the system 300 may include an electrolyzer 202 include an anode 204 a cathode 206 separated by an electrolyte 208. The electrolyzer 202 may be, for example, a protonic ceramic electrolysis cell. As in the system 200, the anode 204 may receive an anode inlet stream 210 containing steam, and in some embodiments, air. The steam in the anode inlet stream 210 may be electrolyzed, forming hydrogen gas at the cathode 206 and oxygen gas at the anode 204. A cathode inlet stream 120 containing nitrogen from the nitrogen separation assembly 118 may be supplied to the cathode 106 as a sweep gas. The cathode outlet stream 122 may thus contain hydrogen formed in the cathode 206 and nitrogen from the nitrogen separation assembly 118. The cathode outlet stream 122 may further contain steam and other gases from the anode inlet stream 210 that have passed through cracks and voids in the electrolyte 208 from the anode 204 to the cathode 206.

Unlike the system 200, the system 300 may not include a water transfer membrane 128. Instead, the system 300 may include a venturi pump 332 (e.g., an ejector). The nitrogen stream 116 from the nitrogen separation assembly 118 may be input into a motive inlet of the venturi pump 302. The cathode outlet stream 122 may be split into a first portion that may form at least a portion of the reactor inlet stream 126 and a second portion forming a cathode recycle stream 330. The reactor inlet stream 126 may be supplied to the ammonia synthesis reactor 124, where the hydrogen and nitrogen may react to form ammonia. The cathode recycle stream 330 may be input into a suction inlet of the venturi pump 332, where the gas may be entrained by the motive flow of nitrogen input into the motive inlet. The cathode recycle stream 330 and the nitrogen stream 116 may thus be mixed in the venturi pump 332 and output to form at least a portion of the cathode inlet stream 120. The cathode inlet stream 120 may contain nitrogen from the nitrogen stream 116, as well as hydrogen, additional nitrogen, and steam from the cathode recycle stream 330. The steam in the cathode inlet stream 120 may hydrate the cathode 206, which may be beneficial, depending on the type of electrolyzer 202. In addition to steam, some oxygen gas from the anode inlet stream 110 and/or oxygen gas formed in the electrolysis reaction may pass through cracks and voids in the electrolyte 208 from the anode 104 to the cathode 106, which can cause oxidation of the nickel or other metals in the cathode 206. The hydrogen from the cathode recycle stream 330 that is reintroduced into the cathode 206 in the cathode inlet stream 120 may protect the cathode 206 from this oxidation.

The system 300 may include a controller 132 configured to control the flow rates of the anode inlet stream 210 and the cathode inlet stream 120, as discussed above with respect to the system 100. The controller 132 may also be configured to adjust the percentage of the cathode outlet stream that is recycled in the recycle stream 330 and the percentage that is supplied to the ammonia synthesis reactor 124 in the reactor inlet stream 126, for example, by sending signals to adjust one or more valves or flow diverters. The system 200 may include sensors 130 communicatively coupled to the controller 132 and configured to measure the concentrations of hydrogen and/or nitrogen at various points in the system 200. The controller 132 may adjust the flow rates based on the data from the sensors 130. At least one of the sensors 130 may be a water concentration sensor configured to measure the concentration of steam in the cathode outlet stream. If the concentration of steam exceeds a predetermined maximum, more of the cathode outlet stream 122 may be directed to the reactor inlet stream 126 to purge more of the steam from the recycle loop. If the concentration of steam fall below a predetermined minimum, more of the cathode outlet stream 122 may be directed to the recycle stream 330 to increase the amount of steam supplied to the cathode 206.

In some embodiments, the systems 100, 200 of FIGS. 1 and 2 may include a venturi pump 332 instead of the water transfer membrane assembly 127, and a portion of the cathode outlet stream 122 may be recycled to the cathode inlet stream 120, similar to the arrangement in the system 300.

In each system 100, 200, 300 described above, the cathode outlet stream 122 may contain primarily hydrogen and nitrogen, with various other gases, such as steam, oxygen, and other trace gases introduced as impurities in the nitrogen stream or that cross over the electrolyte from the anode 104, 204, to the cathode 106, 206. At least some of these gases may be supplied to the ammonia synthesis reactor 124. However, these gases other than hydrogen and nitrogen may be in trace amounts that may not significantly affect the ammonia synthesis process. In some embodiments, the reactor inlet stream 126 may be processed to remove at least some of these impurities. For example, the reactor inlet stream 126 may be cooled until the steam in the reactor inlet stream condenses, and then the condensed water can then be removed from the reactor inlet stream 126. In some embodiments, these other gases may remain in the reactor inlet stream and may slightly reduce the purity of the ammonia produced in the reactor 124.

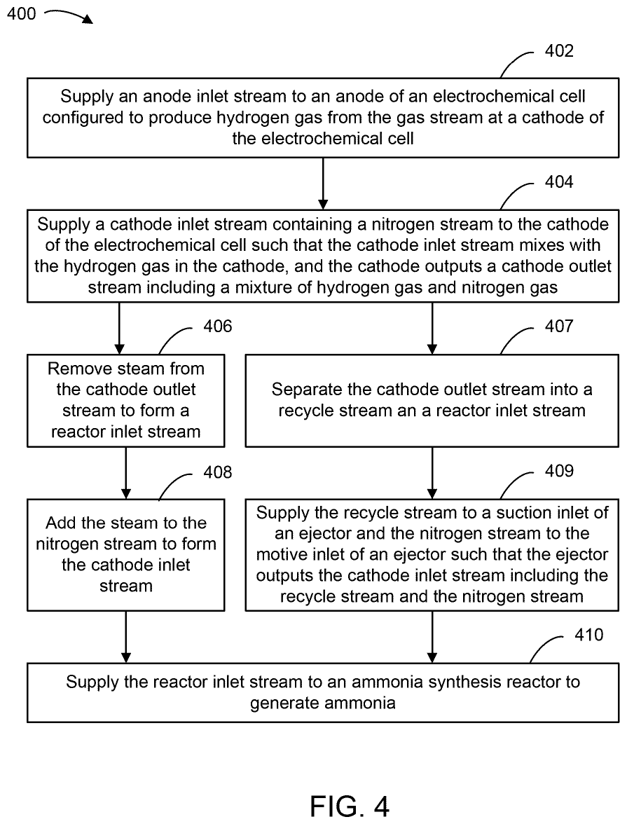

Referring now to FIG. 4, a method 400 of generating ammonia is shown, according to some embodiments. The method may be performed using one of the systems 100, 200, 300. At operation 402 of the method 400, an anode inlet stream may be supplied to an anode of an electrochemical cell, which may produce hydrogen at the cathode of the electrochemical cell. The electrochemical cell may be an EHS (e.g., EHS 102) configured to receive an anode inlet stream including hydrogen gas (e.g., anode inlet stream 110) or an electrolyzer (e.g., electrolyzer 202) configured to receive an anode inlet stream containing steam (e.g., anode inlet stream 210). As discussed above, in either case, the electrochemical reactions occurring in the electrochemical cell may result in the formation of hydrogen gas at the cathode (e.g., the cathode 106, 206). In some embodiments, the method 400 may include operating a fuel cell to generate power and fuel cell anode exhaust. The anode inlet stream of the electrochemical cell may include the fuel cell anode exhaust. At operation 404 of the method 400, a cathode inlet stream (e.g., cathode inlet stream 120) containing a nitrogen stream may be supplied to the cathode. The cathode inlet stream may be mixed with the hydrogen gas formed in the cathode, and the cathode may output a cathode outlet stream including a mixture of hydrogen gas and nitrogen gas (e.g., cathode outlet stream 122). The method 400 may include controlling the supply rate of the anode inlet stream and the cathode inlet stream such that the molar ratio of hydrogen to nitrogen in the cathode outlet stream is about 3:1. The method may include detecting the concentration of hydrogen and the concentration of nitrogen (e.g., using sensors 130) in at least one location, such as in the cathode outlet stream 122, and adjusting the flow rates of at least one of the cathode inlet stream or the anode inlet stream based on the detected concentrations.

In some embodiments, the method 400 may include operations 406 and 408, and in other embodiments, the method 400 may include operations 407 and 409. At operation 406, steam may be removed from the cathode outlet stream to form a reactor inlet stream (e.g., reactor inlet stream 126). The steam may be removed from the cathode outlet stream using a water transfer membrane assembly (e.g., water transfer membrane assembly 127) including a semi-permeable water transfer membrane (e.g., semi-permeable water transfer membrane 128). The steam may cross over the semipermeable water transfer membrane while the remaining gas in the cathode outlet stream may pass through the water transfer membrane assembly without crossing the membrane, forming a dried cathode outlet stream that may form at least a portion of a reactor inlet stream supplied to an ammonia synthesis reactor. At operation 408 of the method 400, the steam may be added to the nitrogen stream to form the cathode inlet stream. Thus, the cathode inlet stream may include nitrogen and steam. The steam in the cathode inlet stream may hydrate and protect the cathode and improve the efficiency of hydrogen ion transport across the electrolyte of the electrochemical cell.

At operation 407 of the method 400, the cathode outlet stream may be separated into a first portion forming recycle stream (e.g., recycle stream 330) and a second portion forming at least a portion of a reactor inlet stream (e.g., reactor inlet stream 126). At operation 409 of the method 400, the recycle stream is supplied to a suction inlet of an ejector (e.g., venturi pump 332), and the nitrogen stream is supplied to a motive inlet of the ejector. The nitrogen stream may entrain and mix with the recycle stream, and the ejector may output the mixture as the cathode inlet stream.

At operation 410 of the method 400, the reactor inlet stream including at least a portion of the cathode outlet stream may be supplied to an ammonia synthesis reactor (e.g., ammonia synthesis reactor 124). As discussed above, the cathode outlet stream may have been dried in the water transfer membrane assembly, or may have been split into two portions, one portion being recycled to the cathode inlet. In the ammonia synthesis reactor, the nitrogen in the hydrogen in the reactor inlet stream may react to form ammonia.

While this specification contains specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations are illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

The controller 132 mentioned above may be implemented via a microprocessor, processor, microcomputer, or computer according to some embodiments. As described above controller 132 may include a processing circuit having at least one processor and at least one memory device and may be configured to communicate with flow control equipment and one or more sensors.

In some embodiments, the processing circuit may be embodied as a machine or computer-readable medium that is executable by a processor. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits or otherwise share the same processor which, in some example embodiments, may execute instructions stored, or otherwise accessed, via different areas of memory. Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device may be communicably connected to the processor to provide computer code or instructions to the processor for executing at least some of the processes described herein. Moreover, the memory device may be or include tangible, non-transient volatile memory or non-volatile memory. Accordingly, the memory device may include database components, object code components, script components, or any other type of information structure for supporting the various activities and information structures described herein.

What is claimed is:

1. An ammonia generation system comprising:
an electrochemical cell comprising:
a cathode configured to receive a cathode inlet stream comprising nitrogen gas;
an anode configured to receive an anode inlet stream and form hydrogen ions;
an electrolyte configured to transport the hydrogen ions from the anode to the cathode,
wherein the cathode is configured to:
reduce the hydrogen ions to hydrogen gas;
mix the hydrogen gas and the cathode inlet stream; and
output a cathode outlet stream comprising a mixture of the hydrogen gas and the nitrogen gas; and
an ammonia synthesis reactor configured to receive a reactor inlet stream comprising at least a first portion of the cathode outlet stream.

2. The ammonia generation system of claim 1, further comprising a water transfer membrane assembly configured to:
receive the cathode outlet stream and a nitrogen stream;
transfer steam from the cathode outlet stream to the nitrogen stream across a semi-permeable water transfer membrane;
output the cathode inlet stream comprising the nitrogen stream and the transferred steam; and
output the reactor inlet stream comprising the dried cathode outlet stream.

3. The ammonia generation system of claim 2, wherein the electrochemical cell is an electrolyzer and the anode inlet stream comprises steam.

4. The ammonia generation system of claim 2, wherein the electrochemical cell is an electrochemical hydrogen separator and the anode inlet stream comprises hydrogen gas.

5. The ammonia generation system of claim 4, further comprising a fuel cell configured to output a fuel cell anode exhaust comprising hydrogen gas, wherein the anode inlet stream of the electrochemical cell comprises the fuel cell anode exhaust.

6. The ammonia generation system of claim 1, further comprising an ejector comprising:
a motive inlet configured to receive a nitrogen stream; and
a suction inlet configured to receive a second portion of the cathode inlet stream,
wherein the ejector is configured to output the cathode inlet stream comprising the second portion of the cathode inlet stream and the nitrogen stream.

7. The ammonia generation system of claim 1, further comprising a controller configured to control a flow rate of the cathode inlet stream and a flow rate of the anode inlet stream.

8. The ammonia generation system of claim 7, further comprising at least one sensor communicatively coupled to the controller and configured to measure at least one of a hydrogen concentration in the cathode outlet stream or a nitrogen concentration in the cathode outlet stream.

9. The ammonia generation system of claim 8, wherein the controller is configured to:
receive a hydrogen concentration measurement and a nitrogen concentration measurement from the at least one sensor;
determine a molar ratio of hydrogen gas to nitrogen gas in the cathode outlet stream based on the hydrogen concentration measurement and the nitrogen concentration measurement; and
adjust at least one of the flow rate of the cathode inlet stream or the flow rate of the anode inlet stream based on the determined molar ratio until the determined molar ratio is approximately 3:1.

10. The ammonia generation system of claim 1, wherein the anode inlet stream comprises hydrogen gas and the electrochemical cell is an electrochemical hydrogen separator.

11. The ammonia generation system of claim 10, wherein the electrochemical hydrogen separator comprises a phosphoric acid electrochemical cell, a polybenzimidazole membrane electrochemical cell, a polymer electrolyte membrane electrochemical cell, a solid acid electrochemical cell, or a protonic ceramic electrochemical cell.

12. The ammonia generation system of claim 1, wherein the anode inlet stream comprises steam and the electrochemical cell is a protonic ceramic electrolysis cell or a polymer electrolyte membrane electrolysis cell.

13. A method of generating ammonia, the method comprising:
supplying an anode inlet stream to an anode of an electrochemical cell configured to produce hydrogen gas at a cathode of the electrochemical cell;
supplying a cathode inlet stream comprising a nitrogen stream to the cathode of the electrochemical cell such that the cathode inlet stream mixes with the hydrogen gas to form a cathode outlet stream; and
supplying a reactor inlet stream comprising at least a portion of the cathode outlet stream to an ammonia reactor.

14. The method of claim 13, further comprising removing steam from the cathode outlet stream to form a dried cathode outlet stream, and adding the removed steam to the nitrogen stream to form the cathode inlet stream, the reactor inlet stream comprising the dried cathode outlet stream.

15. The method of claim 13, further comprising separating the cathode outlet stream into a recycle stream and the reactor inlet stream, supplying the recycle stream to a suction inlet of an ejector, and supplying the nitrogen stream into a motive inlet of the ejector such that the ejector outputs the cathode inlet stream comprising the recycle stream and the nitrogen stream.

16. The method of claim 13, wherein the anode inlet stream comprises hydrogen gas and the electrochemical cell is an electrochemical hydrogen separator.

17. The method of claim 13, wherein the anode inlet stream comprises steam and the electrochemical cell is an electrolysis cell.

18. The method of claim 13, further comprising controlling a flow rate of the cathode inlet stream and a flow rate of anode inlet stream such that a molar ratio of hydrogen gas to nitrogen gas is proximately 3:1.

19. The method of claim 18, further comprising detecting a nitrogen concentration in the cathode outlet stream, detecting a concentration of hydrogen in the cathode outlet stream, and adjusting at least one of the flow rate of the cathode inlet stream and the flow rate of anode inlet stream based on the detected concentrations.

20. The method of claim 13, further comprising operating a fuel cell to generate power and fuel cell anode exhaust, wherein the anode inlet stream of the electrochemical cell comprises the fuel cell anode exhaust.
